(19) United States
(12) Patent Application Publication
(10) Pub. No.: US 2018/0224979 A1
(43) Pub. Date: Aug. 9, 2018

(54) KEYBOARD/HANDWRITING DUAL INPUT DEVICE

(71) Applicant: Shenzhen Sunia Technology Company Ltd, Shenzhen (CN)

(72) Inventors: Jianming Zhuang, Shenzhen (CN); Minghui He, Shenzhen (CN); Jianbo Wang, Shenzhen (CN)

(21) Appl. No.: 15/460,174

(22) Filed: Mar. 15, 2017

(30) Foreign Application Priority Data
Feb. 7, 2017 (CN) 201720113538.2

(51) Int. Cl. G06F 3/046; G06F 1/16; G06F 3/0488

(52) U.S. Cl. CPC G06F 3/046; G06F 1/1611; G06F 3/04883; G06F 1/1666

(57) ABSTRACT

The dual input device has a keyboard on the front side of the input device, a display screen on the back side of the input device, an electromagnetic touch panel and a control circuit between the front side and the display screen. The keyboard, the display screen, and the electromagnetic touch panel are connected with the control circuit, respectively. The control circuit includes a direction control circuit for controlling the On/Off of the keyboard, the display screen and the electromagnetic touch panel. Through the direction control circuit, the input device combines the traditional keyboard and the writing pad in a single dual input device. In addition, because the electromagnetic touch panel is placed behind the display screen, the input data can be displayed in real time, and the original handwriting can be saved.

### TECHNICAL FIELD

The invention relates to input device, in particular to a dual input device allowing input through a keyboard or by handwriting on a display screen thereof.

### TECHNICAL BACKGROUND

A keyboard is the most commonly used input device. A keyboard can input English letters, numbers, punctuation and other characters to the computer to command the computer to enter data, but it is inconvenient for those who do not have good typing skills or who do not know input methods, such as Pinyin input method for entering Chinese characters. They need to use handwriting and other auxiliary input tools instead of the keyboard.

As the keyboard and the handwriting pad are two separate devices, the keyboard can only process keystrokes for text editing and the handwriting pad can only accept hand-written text on the writing pad. It takes up space to have both devices, and it is not easy to carry them around.

### BRIEF SUMMARY OF THE INVENTION

In view of the above-mentioned problems, the present invention provides a dual input device, which eliminates the inconvenience of having both the keyboard and writing pad for a computer or other electronic devices.

The dual input device of the present application comprises a keyboard on the front side, a display screen on the back side, an electromagnetic touch panel and its control circuit between the keyboard and the display screen. The keyboard, the display screen and the electromagnetic touch panel are respectively connected with the control circuit. The control circuit comprises a direction control circuit for controlling the on-off of the keyboard, the display screen and the electromagnetic touch panel.

In the input device according to the present application, the display screen and the electromagnetic touch panel are integrated on the back of the keyboard, and the user can normally use the keyboard on the front side for input. When the user needs to do input by handwriting, he/she uses the touch display screen on the back side, while a direction control circuit controls the On/Off of the traditional keyboard and the touch screen. The combination input device effectively save space, and is convenient for users to carry around. In addition, the electromagnetic touch technology can let user see their writing on the display screen, and save the original writing.

The control circuit may further comprise a microcontroller which is connected to the keyboard, the display screen and the electromagnetic touch panel, respectively. The direction control circuit is connected to the microcontroller as well.

In this technical scheme, the microcontroller in the control circuit realizes the control of the current on/off among the keyboard, the display screen and the electromagnetic touch panel. Furthermore, the microcontroller comprises a storage module to keep the original handwriting, so that the user can write on the screen as fast as possible, without any concerns about errors that may occur in the recognition process to interrupt the writing.

Further preferably, the control circuit also comprises a wireless transmission module, which is connected to the microcontroller. In this technical scheme, it is simple and convenient to transmit the input data to a smart device such as a computer or a mobile phone.

One more advantage is that on top of the display screen a gripper may be disposed for holding a writing paper sheet.

In this technical solution, it is possible to carry out rapid writing on paper, and transmit it to a smart device such as a computer or a mobile phone to save the original handwriting. People can save their original handwriting in the computer or phone memory instead of on paper, for example, they can write the bank signature on the device and save the original handwriting. This way, less paper will be used.

### BRIEF DESCRIPTION OF THE DRAWINGS

Below is provided a brief description of the drawings for explaining the dual input device of the present application in more detail.

FIG. 1 is the front view of a conventional keyboard for a computer or other electronic devices.

FIG. 2 is the back view of the conventional keyboard.

FIG. 3 is a lateral view of the conventional keyboard.

FIG. 4 is a front view of the input device according to the present application.

FIG. 5 is a back view of the input device according to the present application.

FIG. 6 is a lateral view of the input device according to the present application.

FIG. 7 is a control circuit diagram for the input device according to the present application.

FIG. 8 is a back view of the input device according to the present application shown with a sheet of writing paper.

FIG. 9 is a lateral view of the input device shown in FIG. 8.

FIG. 10 is a lateral view of the input device shown according to the present application shown with a wireless transmission module.

### REFERENCE CHARACTERS IN THE DRAWINGS ARE:

10—dual input device of the present application

120—front side of the input device

121—back side of the input device

122—lateral side of the input device

123—writing paper

124—display screen

125—electromagnetic touch panel

126—microcontroller

127—direction control circuit

128—keyboard

129—gripper or groove for holding paper

### DETAILED DESCRIPTION OF THE INVENTION

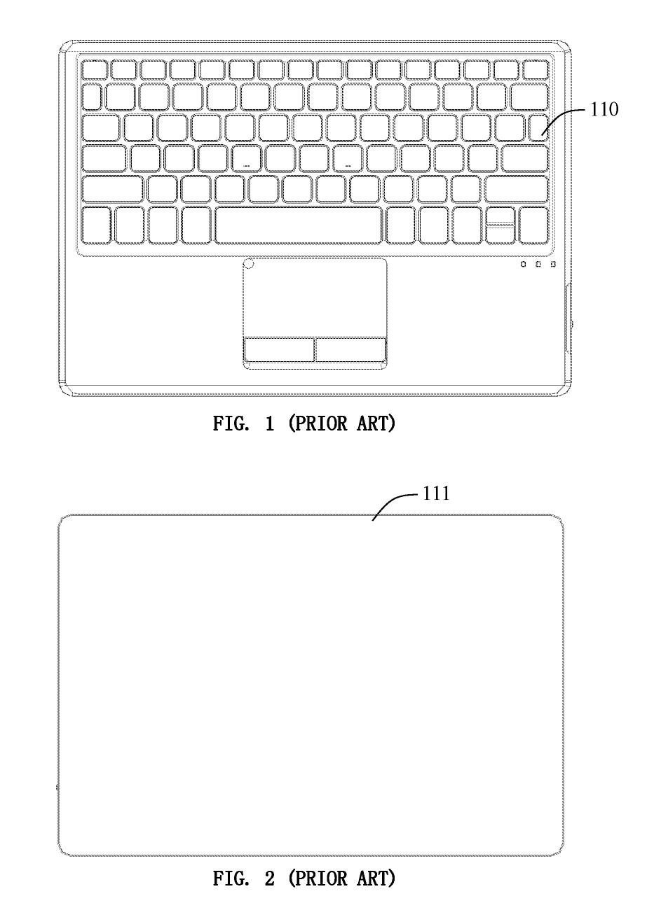

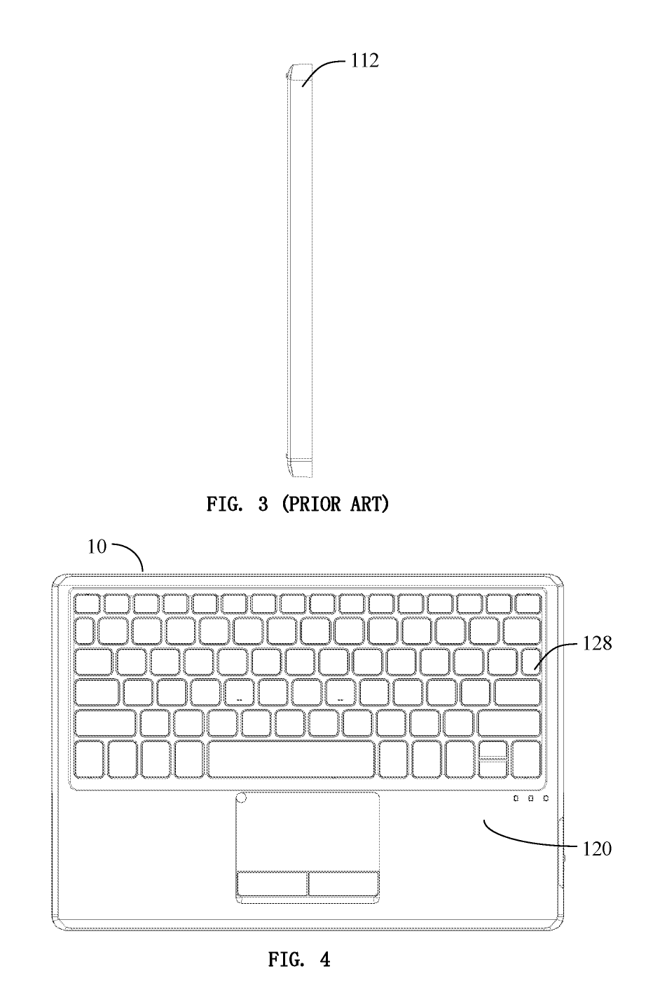

FIGS. 1-3 show various views of a conventional standard keyboard device, showing a front side 110, a back side 111, and a lateral side 112. As can be seen, the back side 111 of the conventional keyboard is just a flat surface without any additional structure/device, and the keyboard has only the most common used input function.

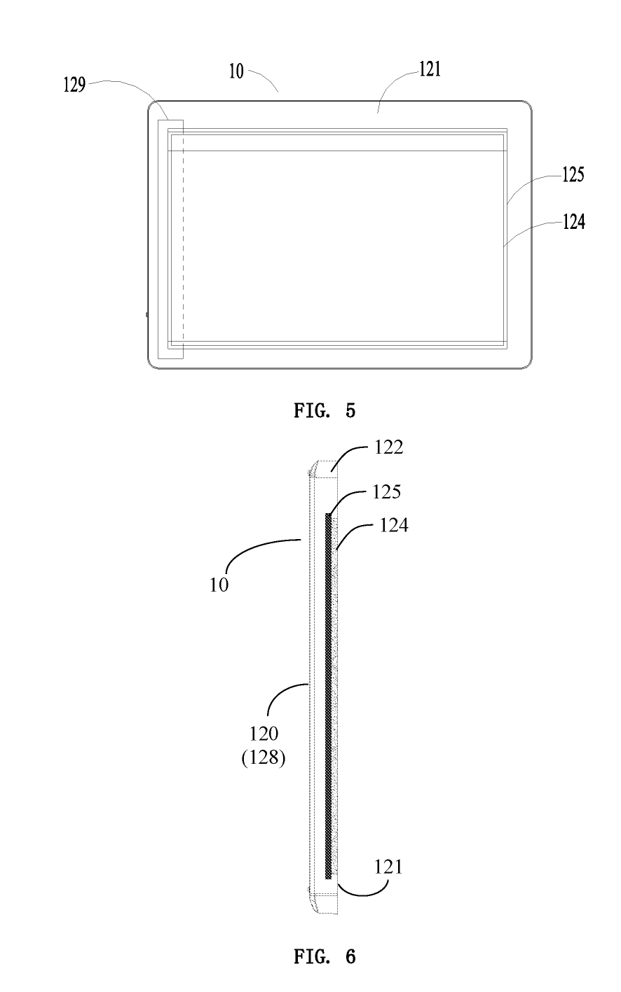

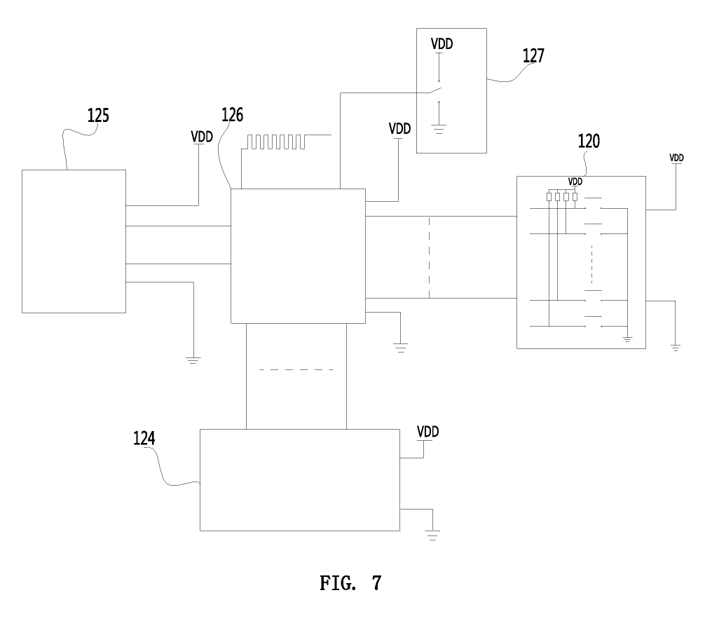

FIGS. 4-6 show the corresponding views of the dual input device 10 according to the present application. FIG. 4 shows the front side 120 with a keyboard 128, FIG. 5 shows the back side 121, and FIG. 6 shows the lateral side 122 of the input device 10. As can be seen from the drawing, the input device 10 includes: a keyboard 128 provided on the front side 120 of the input device 10, a display screen 124 provided on the back side 121 of the input device 10, an electromagnetic touch panel 125 provided between the front side 120 and the display screen 124. The keyboard 128, the display screen 124 and the electromagnetic touch panel 125 are respectively connected to a control circuit (shown in FIG. 7). The control circuit includes a direction control circuit 127 for controlling On/Off of the keyboard 128, the display screen 124 and the electromagnetic touch panel 125. To be more specific, a microcontroller 126 is also included in the control circuit, and the microcontroller 126 is connected to the keyboard 128, the display screen 124, the electromagnetic touch panel 125, and the direction control circuit 127, respectively.

As shown in the lateral view of the input device 10 in FIG. 6, the electromagnetic touch panel 125 is set in between the front side 120 and the back side 121, and the display screen 124 is placed behind the electromagnetic touch panel 125 (opposite to the keyboard 128). FIG. 7 is a circuit connection diagram of the control circuit of the input device 10 to the keyboard 128, the display screen 124, and the electromagnetic touch panel 125. The operation principle of the input device 10 is described below.

When the input device 10 is placed with the keyboard 128 facing up, the input device 10 operates in the normal keyboard input mode. The direction control circuit 127 will send a high/low level control signal to the microcontroller 126, and the microcontroller 126 sets the keyboard 128 in the operative state while keeping the electromagnetic touch panel 125 and the display screen 124 in the non-operative state, namely, keeping the output port of the keyboard 128 operative only. At this moment, as long as the input device 10 is connected with the computer, the keyboard input function will be in operation.

Conversely, the input device 10 operates in the handwriting input mode when the input device 10 is placed with the front side 120 facing down. In this mode, the direction control circuit 127 will send a high/low level control signal to the microcontroller 126, whereby the microcontroller 126 sets the electromagnetic touch panel 125 and the display screen 124 in the operative state, and when the user writes on the display screen 124 (e.g. by a stylus), the electromagnetic touch panel 125 converts the handwriting strokes and intensity into digital data to transfer to the microcontroller 126, the microcontroller 126 then transfers the data to the display screen 124 to display it. The display screen 124 displays the handwriting in real time. In addition, if the input device 10 remains connected to an electronic device such as a computer, the handwriting input data can be transferred to the device. Of course, if the input device 10 is not connected with a device during writing, the display screen 124, after recording the handwritten text, may then send the recorded text via wireless transmission to a device to store the original handwriting.

In one embodiment, the low level control signal controls the electromagnetic touch panel 125 and the display screen 124 to be in the non-operative state. On the other hand, a high level control signal controls the input device 10 to operate in the normal keyboard input mode. When the keyboard 128 on the front side 120 is in operation, the direction control circuit 127 (as shown in FIG. 7) is switched to VDD (Power supply) to send a high level control signal to the microcontroller 126, thus controlling the keyboard to be in operation. At the same time, the direction control circuit 127 outputs a low level control signal (by switching the direction control circuit 127 to the ground terminal as shown in FIG. 7) to the microcontroller 126 to control the electromagnetic touch panel 125 and the display screen 124 to be in the non-operative state. Accordingly, when the input device 10 is placed with the back side 121 up, the input device 10 operates in the handwriting input mode through the direction control circuit 127, which sends a low level control signal to the microcontroller 126 to control the keyboard 128 to be in the non-operative state, and sends a high level control signal to the microcontroller 126 to control the electromagnetic touch panel 125 and the display screen 124 to be in the operative state. This will make the display screen 124 and the output port of the electromagnetic touch panel 125 active, thereby keeping the handwriting function.

In the above, the direction control circuit 127 controls the on/off of the keyboard 128, the display screen 124, and the electromagnetic touch panel 125 by switching to the power source and the ground terminal. In an alternative embodiment, the direction control circuit 127 may create the direction control command to control the on-off of the keyboard 128, the display screen 124 and the electromagnetic touch panel 125. For example, the input device 10 operates in the normal keyboard input mode, i.e. when the input device 10 is placed with the keyboard 128 facing up, the direction control circuit 127 outputs a direction control command to the microcontroller 126, whereby the microcontroller 126 sets the keyboard 128 to be in the operative state, while controlling the electromagnetic touch panel 125 and the display screen 124 to be in the non-operative state. Namely, only out port of the keyboard 128 is operative. As long as the input device 10 keeps the connection with an electronic device such as a computer, the keyboard 128 will remain in the input mode, and the input data will be transmitted to the electronic device.

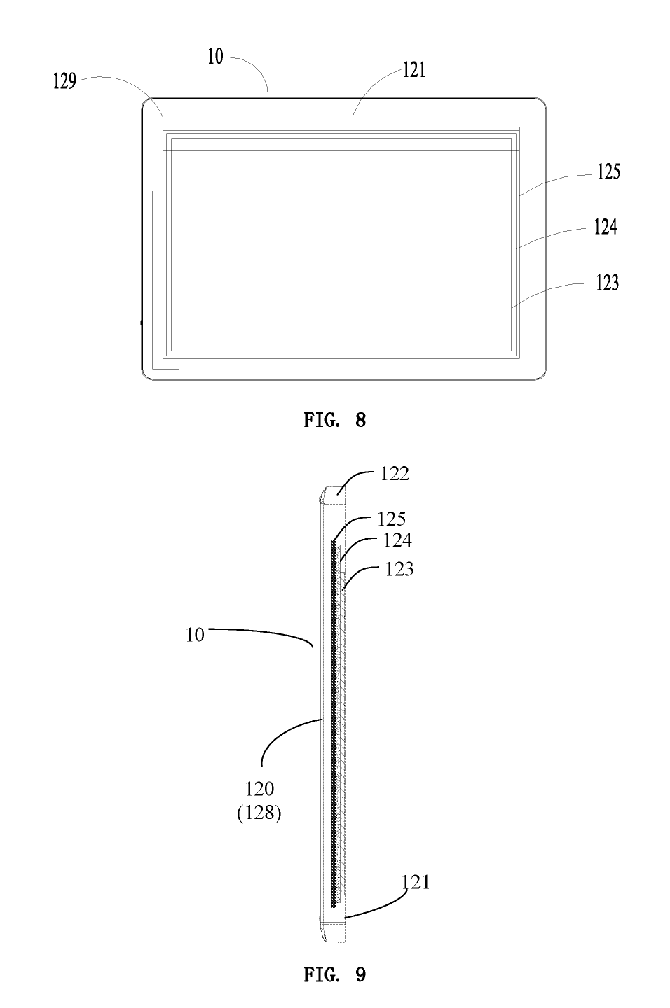

A further improved embodiment is shown in FIG. 8 and FIG. 9. FIG. 8 shows the structure of the back side 121 of the input device 10, and FIG. 9 shows the structure of the lateral side 122 of the input device 10. In this embodiment, the input device 10 includes a keyboard 128 on the front 120, a display screen 124 on the back side 121 of the input device 10, an electromagnetic touch panel 125 between the front side 120 and the display screen 124, a control circuit (as described above), and a gripper or groove 129 provided on the top of the display screen 124 for holding a sheet of writing paper 123. With this embodiment, the user can directly write on the writing paper 123 and thereafter connect it to a smart device such as a computer or a mobile phone to store the original handwriting. For example, signatures in the original handwriting stored in computers, mobile phones and other smart devices may be used in transactions with banks and other institutions, thus saving time and paper.

In this embodiment of the present application, the normal operation mode of the keyboard 128 and the handwriting input mode through the display screen 124 are the same as those described above and will not be described again here. In the following, the difference in the operation of the writing paper sheet 123 will be described.

In operation, first place the writing paper 123 directly above the display screen 124, the high/low level control signal is provided to the microcontroller 126 by the direction control circuit 127, whereby the microcontroller 126 sets the electromagnetic touch panel 125 and the display screen 124 in the operative state, so that when the pen is written on the writing paper 123, the electromagnetic touch panel 125 collects and transmits the data corresponding to the handwriting on the writing paper 123 to the microcontroller 126 and the microcontroller 126 then transfers the original handwriting on the writing paper 123 to the display screen 124 to be displayed on the display screen 124. This way, the handwriting input is displayed on the display screen 124 in real time. At this time, if the input device 10 is connected with a smart electronic device such as a computer, the handwriting contents on the writing paper 123 will be simultaneously displayed on the display screen 124 of the input device 10 and on the display of the smart electronic device, thereby realizing the synchronous display of the handwriting. Of course, if the keyboard is not connected with the smart device during the writing process, the contents of the writing paper sheet 123 and the display screen 124 may be transferred to the smart device afterward. After receiving the contents of the writing paper 123 and the display panel 124, the smart device, such as a computer, stores the original handwriting.

In another embodiment of the input device 10, the high level control signal controls the electromagnetic touch panel 125 and the display screen 124 to be in the non-operative state, and the low level control signal controls the keyboard 128 in the operative state. The input device 10 operates in the handwriting input mode, i.e. when the input device 10 is placed with the back side 121 up during operation, a high level control signal is provided through the direction control circuit 127 in the control circuit to the microcontroller 126 to control the keyboard 128 to be in the non-operative state, and a low level control signal is provided to the microcontroller 126 to control the electromagnetic touch panel 125 and the display screen 124 to be in an operative state, thereby maintaining the output ports of the display screen 124 and the electromagnetic touch panel 125 operative for a handwriting function.

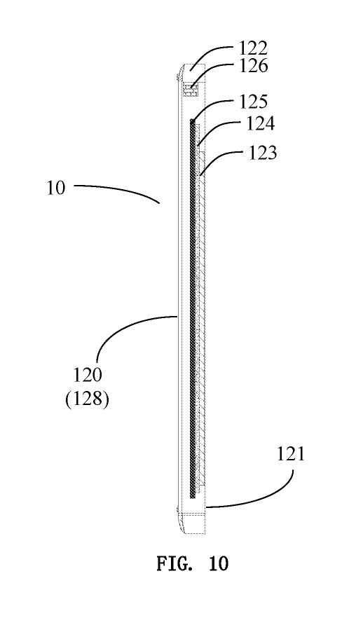

In the input device 10 shown in FIG. 10, the control circuit further includes a wireless transmission module connected to the microcontroller 126, whereby the input device 10 is not required to pass data through wired connection to the computer or other smart devices. The wireless transmission module, such as a WiFi (Wireless Fidelity) module or Bluetooth module, can wirelessly transfer keyboard/handwritten input data to the smart device.

Based on the above description, the dual input device 10 according to the present invention has a writing function display screen (LCD), an electromagnetic touch panel, a notebook (writing paper) and a wireless transmission module, namely, the dual input device is a four-in-one input device. With this input device, a user who types slowly, when asked to quickly record the text, no longer needs to constantly tap the keyboard and learn complicated input method; he/she can just pick up the pen and write on the LCD screen on the back side of the dual input device or on a sheet of writing paper attached to the back side of the input device, and the original handwriting will be saved directly to the computer or other smart devices, or be directly sent to the relevant personnel. For banks and other institutions, signature can be directly signed on the display screen on the back side of the input device and the original handwriting signature will be saved without the need to save the signature on paper, thus saving time, labor and cost.

What is claimed is:

1. An input device comprising: a keyboard provided on a front side thereof, a display screen provided on a back side thereof, an electromagnetic touch panel and a control circuit provided between the front side and the display screen, wherein the keyboard, the display screen and the electromagnetic touch panel are respectively connected with the control circuit, and the control circuit includes a direction control circuit for controlling the On/Off of the keyboard, the display screen and the electromagnetic touch panel.

2. The input device as claimed in claim 1, wherein the keyboard, the display panel, and the electromagnetic touch panel are respectively turned On and Off by switching between a power supply terminal and a ground terminal of the direction control circuit.

3. The input device as claimed in claim 2, wherein the control circuit further comprises a microcontroller connected to the keyboard, the display screen and the electromagnetic touch panel, respectively, and the microcontroller is further connected to the direction control circuit.

4. The input device as claimed in claim 3, wherein the control circuit further comprises a wireless transmission module for transmitting input data to an electronic device in real time, and the wireless transmission module is connected to the microcontroller.

5. The input device as claimed in claim 1, further comprising a gripper for holding writing paper on top of the display screen.

6. The input device as claimed in claim 2, further comprising a gripper on top of the display screen for holding writing paper.

7. The input device as claimed in claim 3, further comprising a gripper on top of the display screen for holding writing paper.

8. The input device as claimed in claim 4, further comprising a gripper on top of the display screen for holding writing paper.

9. The input device as claimed in claim 1, wherein a groove is disposed on a surface of the display screen for holding writing paper.

10. The input device as claimed in claim 2, wherein a groove is disposed on a surface of the display screen for holding writing paper.

11. The input device as claimed in claim 3, wherein a groove is disposed on a surface of the display screen for holding writing paper.

12. The input device as claimed in claim 4, wherein a groove is disposed on a surface of the display screen for holding writing paper.

13. The input device as claimed in claim 3, wherein:
when the input device is positioned with the keyboard facing upwards, the direction control circuit sends a high level control signal to the microcontroller to set the keyboard in an operative state, and sends a low level control signal to the microcontroller to set the display screen and the electromagnetic touch panel in a non-operative state; and
when the input device is positioned with the display screen facing upwards, the direction control circuit sends a low level control signal to the microcontroller to set the keyboard in a non-operative state, and sends a high level control signal to the microcontroller to set the display screen and the electromagnetic touch panel in an operative state.
